(19) United States
(12) Patent Application Publication
(10) Pub. No.: US 2019/0223662 A1
(43) Pub. Date: Jul. 25, 2019

(54) Grill Converter

(71) Applicant: Ralph Kline, Reed City, MI (US)

(72) Inventor: Ralph Kline, Reed City, MI (US)

(21) Appl. No.: 16/155,399

(22) Filed: Oct. 9, 2018

Related U.S. Application Data
(60) Provisional application No. 62/621,926, filed on Jan. 25, 2018.

(51) Int. Cl. A47J 37/07

(52) U.S. Cl. CPC A47J 37/0786

(57) ABSTRACT

A grill converter having a plurality of planar members with an upper end and a lower end sized to fit vertically inside of a grill. The grill converter also has a front surface and a rear surface adapted to sustain high grilling temperatures with a notch disposed on an inside surface between the planar members, which forms an elongated slot opening that is disposed on a central section of the planar members and adapted to allow heat and smoke therethrough.

### CROSS REFERENCE TO RELATED APPLICATIONS

This application claims the benefit of U.S. Provisional Application No. 62/621,926 filed on Jan. 25, 2018. The above identified patent application is herein incorporated by reference in its entirety to provide continuity of disclosure.

### BACKGROUND OF THE INVENTION

The present invention relates to a grill converter for use in smoking food. Many people enjoy the taste of food prepared over a charcoal grill. Smoking is the process of flavoring, browning, cooking, or preserving food by exposing it to smoke from burning or smoldering material, such as wood or charcoal. The process of smoking involves providing indirect heat to food and applying different cooking conditions to the food as opposed to grilling food over direct heat. Indirect heat can be achieved in a charcoal grill by placing the burning fuel source on one side of the grill and the food on the other side. However, this has not proven to be an effective method of separation because fluids produced in the cooking process may drip onto the burning fuel source, causing flames to develop. These flames may cause the food to burn or dry out during the cooking process. Some dedicated smoking devices are known, yet they are often expensive and are typically hard to clean. Therefore, there is a need for an improved grill converter.

Devices have been disclosed in the known art that generally relate to grill converters or smoker devices for grills. These include devices that have been patented and published in patent publications. However, these devices do not disclose a grill converter comprising a plurality of planar members with an elongated slot opening disposed on a central section of the plurality of planar members that laterally allows heat and smoke through the opening to smoke a desired meat without fluid dripping onto the burning fuel source. Additionally, these devices do not disclose a grill converter that is removable and easy to clean.

### SUMMARY OF THE INVENTION

In view of the foregoing disadvantages inherent in the known art it is submitted that the present invention substantially diverges in design elements from the prior art and consequently it is clear that there is a need in the art for an improvement to existing illuminated stand devices. In this regard the instant invention substantially fulfills these needs.

It is therefore an object of the present invention to provide a new and improved grill converter.

It is another object of the present invention to provide a grill converter comprising a plurality of planar members with an upper end and a lower end sized to fit vertically inside of a grill and a front surface and a rear surface adapted to sustain high grilling temperatures.

Another object of the present invention is to provide a grill converter comprising a notch disposed on an inside surface of the planar member and an elongated slot opening disposed on a central section of the plurality of planar members being adapted to allow heat and smoke therethrough.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the grill converter.

FIG. 2 shows an alternate perspective view of an embodiment of the grill converter.

FIG. 3 shows a perspective view of an embodiment of the grill converter in use with a charcoal grill.

### DETAILED DESCRIPTION OF THE INVENTION

Reference is made herein to the attached drawings. Like reference numerals are used throughout the drawings to depict like or similar elements of the grill converter. The figures are intended for representative purposes only and should not be considered to be limiting in any respect.

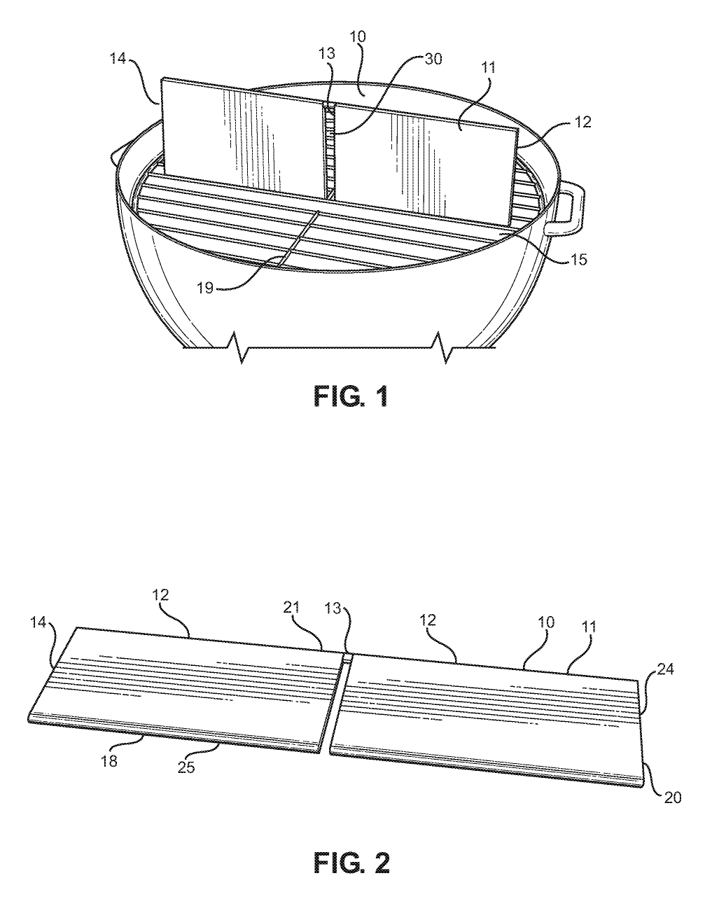

Referring now to FIG. 1 and FIG. 2, there is shown a perspective view of an embodiment of the grill converter in use and an alternate perspective view of an embodiment of the grill converter. In the shown embodiment, the grill converter 10 comprises a plurality of planar members 12 each having a unitary, elongated body with an upper end 11 and a lower end 18 sized to fit inside a grill, wherein the grill is a standard sized grill having a cooking area of 450 to 500 square inches with a cooking grate disposed thereon. The grill converter 10 is sized to fit through a cooking grate 15 with latitudinal and longitudinal cross bars, wherein the grill converter 10 is configured to slide through the space between a pair of parallel bars of the cooking grate 15 and rest in a center section 19 of the grill. The upper end 11 and the lower end 18 of the planar members 12 are a shorter length than at least one lateral edge 14, 20 creating a rectangular shape, wherein the edges 14, 20 comprise a first end 14 and second end 20 disposed on opposite ends of the planar members 12.

In the shown embodiment, the grill converter 10 further comprises a planar front surface 24 and an opposing planar rear surface 25 each adapted to sustain high temperatures, wherein the front and rear surfaces 24, 25 are made of a fire-resistant material, such as industrial glass, silica materials, or other suitable materials. The front and rear surfaces 24, 25 also have a smooth, low-friction finish allowing the grill converter 10 to slide easily between the cross bars of the cooking grate 15. The smooth finish also allows for the front and rear planar surfaces 24, 25 to be easily cleaned, because ash and soot from the wood or charcoal will not get stuck in grooves and crevices present on a rough or uneven surface. In the shown embodiment, the planar members 12 are a rectangular shape. However, in an alternate embodiment the planar members can be any suitable shape to correspond with the shape of the grill, such as a circle or a square. Further, the front surface 24 and rear surface 25 of the planar members 12 are made of a thermal-insulating material, such as a polyimide foam, which protects fire and charcoal from ambient wind.

In the shown embodiments, the planar members 12 are connected by a notch 13 disposed on a top edge 21 of a central section 22 between the planar members 12. The notch 13 is also made of thermal-insulating material, such as polyimide foam and a fire-resistant material, such as industrial glass, silica materials or another suitable material. In the shown embodiment, the notch 13 is circular in shape; however, in an alternate embodiment, the notch 13 can be any suitable shape to connect the planar members 12, such as a square or rectangle. The notch 13 defines an elongated slot opening 30 disposed between the planar members 12.

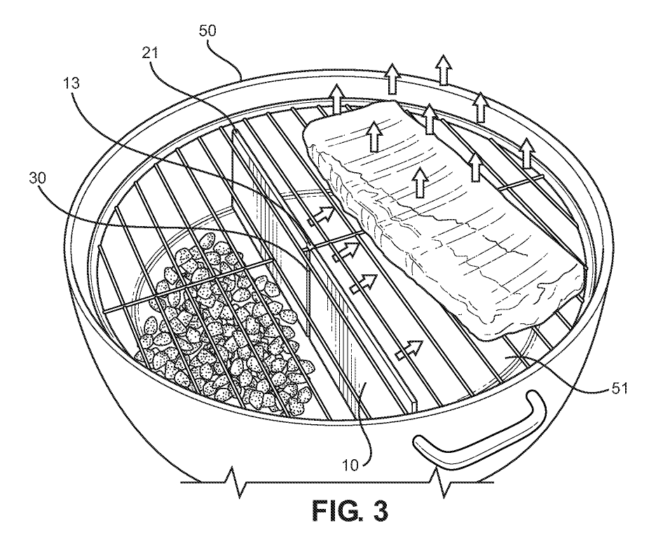

Referring now to FIG. 3, there is shown a perspective view of an embodiment of the grill converter in use. In the shown embodiment, the notch 13 creates an elongated central slot opening 30 extending away from the top edge 21, such that the elongated central slot opening 30 is positioned between the planar members. When the grill converter 10 is inserted into a grill, it divides the grill into two sections, wherein a first section 50 contains charcoal and fire and a second section 51 contains any suitable material for imparting flavor, such as various types of wood chips. The elongated slot opening 30 allows heat from the charcoal and fire in the first section 50 to pass through to the second section 51 of the grill. The heat then combines with the flavoring material and is transferred vertically to a food item cooking on the cooking grate. In this way, the meat is cooked through indirect heat. The elongated central slot opening 30 controls the amount of heat transferred to the selected meat by blocking the amount of heat allowed to transfer to the second section of the grill. Further, the two sections can be used simultaneously for different types of cooking. For example, the first section 50 can be used for cooking food with direct heat while the second section 51 can be used for cooking food with indirect heat.

In the shown embodiment, grease and liquids from the cooking food would drop downward through the top grill opening into the second section of the grill, but not onto the heat element in the first section as in conventional meat smokers. Thus, the problem of flare-ups caused by grease burning when it falls on the flame is eliminated.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A grill converter, comprising:
a plurality of planar members having an upper end and a lower end sized to fit inside a grill;
a front surface and a rear surface adapted to sustain high temperatures;
a notch disposed between each planar member of the plurality of planar members;
an elongated slot opening defined by the notch, wherein the elongated slot is adapted to allow heat and smoke therethrough.

2) The grill converter of claim 1, wherein the plurality of planar members is made of a fire-resistant material.

3) The grill converter of claim 1, wherein the upper end and the lower end of the planar member is a shorter length than at least one lateral edge.

4) The grill converter of claim 1, wherein the notch is disposed the upper end of the plurality of planar members and is configured to connect each of the plurality of planar members to each other.

5) The grill converter of claim 1, wherein the front surface and the rear surface are made of a heat-insulating material.

6) The grill converter of claim 1, wherein the lower end of the planar member is configured to fit below a grate of a grill.
